(19) United States
(12) Patent Application Publication
(10) Pub. No.: US 2005/0259773 A1
(43) Pub. Date: Nov. 24, 2005

(54) Method and apparatus for synchronizing transmissions

(76) Inventor: Chris L. Fay, Wheaton, IL (US)

Correspondence Address: MOTOROLA, INC., 1303 EAST ALGONQUIN ROAD, IL01/3RD, SCHAUMBURG, IL, 60196, US

(21) Appl. No.: 10/852,329

(22) Filed: May 24, 2004

(51) Int. Cl. H04B 3/00; H04L 25/00; H04L 7/00

(52) U.S. Cl. 375/354; 375/257

(57) ABSTRACT

In order to properly synchronize a communication system (100), a synchronization pulse is combined with DC power distribution. This is accomplished by interrupting the DC power that is supplied to each access point radio (102). The interruption occurs on a rising edge of the precision timing reference and lasts for a predetermined time. This pulsed-DC signal is utilized to prevent transmission by an access point during a receive cycle of other access points.

### FIELD OF THE INVENTION

The present invention relates generally to communication systems, and in particular, to a method and apparatus for synchronizing transmissions within such communication systems.

### BACKGROUND OF THE INVENTION

Communication systems often synchronize their transmisions in order to reduce system interference. More particularly, because several transmitters may need to transmit information within a communication system, it is beneficial to synchronize transmissions among the transmitters so that overall system interference is reduced. Because of this, each transmitter within the communication system must be provided with an accurate time source to aid synchronization. Prior-art communications have placed very accurate and expensive clocks in each transmitter, or have placed Global Positioning System (GPS) receivers within each transmitter to provide the clocking signal. Other prior-art systems reduce the amount of equipment needed by feeding a clocking signal to each transmitter via cabling.

Regardless of the prior-art technique used to synchronize a communication system, each of the above methods requires either clocking equipment to exist at each transmitter, or excessive cabling in order to provide the clocking signal. Therefore a need exists for a method and apparatus for synchronizing transmissions that does not require clocking equipment to exist at each transmitter, and does not require excess cabling to provide the clocking signal to the transmitter.

### BRIEF DESCRIPTION OF THE DRAWINGS

FIG. 1 is a block diagram of a communication system.

FIG. 2 is a more-detailed block diagram of the communication system of FIG. 1.

FIG. 3 illustrates DC power provided to an access point.

FIG. 4 is a flow chart showing operation of a cluster management module of FIG. 2.

FIG. 5 is a flow chart showing operation of an access point radio of FIG. 2.

### DETAILED DESCRIPTION OF THE DRAWINGS

To address the above-mentioned need a method and apparatus for synchronizing transmissions within a communication system is provided herein. In order to properly synchronize a communication system, a synchronization pulse is combined with DC power distribution. This is accomplished by interrupting the DC power that is supplied to each access point radio. The interruption occurs on a rising edge of the precision timing reference and lasts for a predetermined time. This pulsed-DC signal is utilized for synchronization purposes, and in particular to prevent transmission by an access point during a receive cycle of other access points. This technique is preferred over prior-art synchronization techniques since the above technique does not require clocking equipment to exist at each access point, nor does it require excess cabling utilized to provide the clocking signal.

The present invention encompasses a method for synchronizing transmissions within a communication system. The method comprises the steps of utilizing a timing signal to produce a pulsed-DC signal, and outputting the pulsed-DC signal to a radio, wherein the pulsed-DC signal is utilized both to power the radio, and as a timing source for synchronization purposes.

The present invention additionally encompasses a method for synchronizing transmission within a communication system. The method comprises the steps of receiving a pulsed-DC signal and utilizing the pulsed-DC signal as both a power source and as a timing signal for synchronizing transmissions.

The present invention additionally encompasses an apparatus comprising pulse-shaping logic having a timing signal as an input and outputting a pulsed-DC signal, and a power amplifier having the pulsed-DC signal as an input and outputting the pulsed-DC signal to a radio, wherein the pulsed-DC signal is utilized both to power the radio, and as a timing source for synchronization purposes.

The present invention additionally encompasses an apparatus comprising a power supply receiving a pulsed-DC signal, timing circuitry receiving the pulsed-DC signal, and outing a timing signal, and a transmitter utilizing the power supply as a power source and utilizing the iteming signal for synchronization.

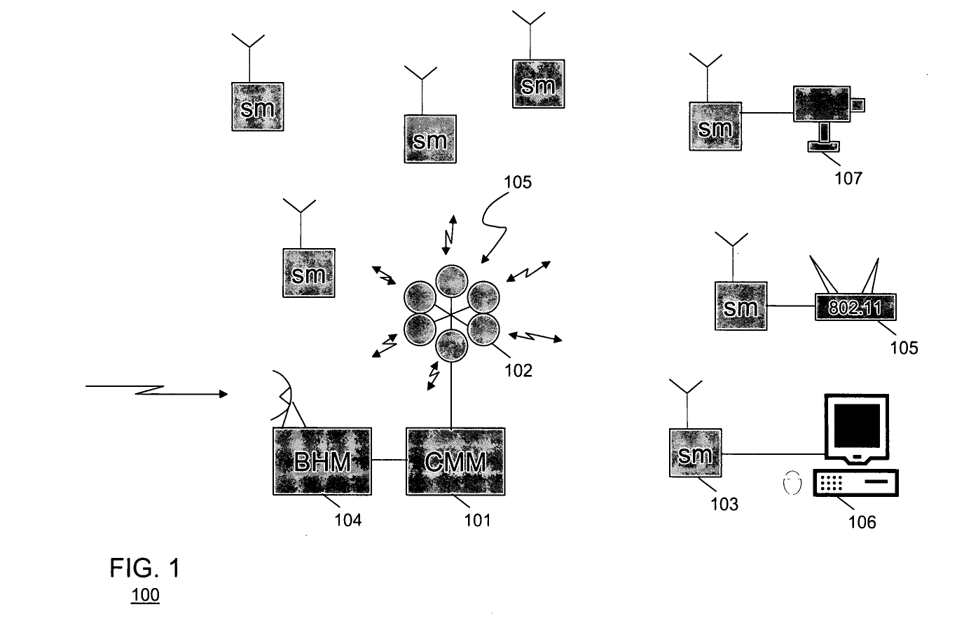

Turning now to the drawings, wherein like numerals designate like components, FIG. 1 is a block diagram of communication system 100. In the preferred embodiment of the present invention communication system 100 is a Motorola Canopy™ Broadband Wireless Internet Platform available from Motorola, Inc. However in alternate embodiments of the present invention, communication system 100 may comprise any communication system requiring synchronization between transmitters and receivers. As shown, communication system 100 comprises cluster management module 101, plurality of access points 102 (only one labeled), plurality of subscriber modules 103 (only one labeled), and backhaul master (BHM) 104. In the preferred embodiment of the present invention, all network elements are available from Motorola, Inc. (Motorola Inc. is located at 1301 East Algonquin Road, Schaumburg, Ill. 60196). It is contemplated that network elements within communication system 100 are configured in well known manners with processors, memories, instruction sets, and the like, which function in any suitable manner to perform the function set forth herein.

During operation, backhaul master 104 receives a remote internet feed comprising data to be transmitted to at least one service module 103. The data is passed to cluster management module 101 where it is routed to the appropriate access point 102. In particular, cluster management module 101 comprises an Ethernet switch that directs data to an appropriate access point 102. Each access point 102 comprises a direct 100baseT Ethernet connection to cluster management module 101. Each access point 102 is designed to serve up to 200 subscriber modules 103, with the six access points 102 in cluster 105 capable of serving 1200 service modules 103. Once data is received by an access point, the access point determines the appropriate service module 103 and transfers the data to the service module via an over-the-air communication link. Each service module 103 comprises a direct Ethernet connection to a local node, providing a remote data feed. For example service module 103 may provide a backhaul to 802.11 hot spot 105, or deliver internet access to personal computer 106, or backhaul to internet webcam 107.

As discussed above, because several access points 102 may need to simultaneously transmit information within communication system 100, it is beneficial to synchronize transmissions among the transmitters so that overall system interference is reduced. Because of this, each transmitter within the communication system must be provided with an accurate time source to aid in synchronization. Within the Canopy system cluster management module 101 provides synchronization to cluster 105. In the preferred embodiment of the present invention cluster management module 101 is equipped with a GPS receiver and provides a GPS timing pulse to each access point 102. Each access point 102 then utilizes this timing information to synchronize transmission/reception of data. Without the timing pulse, an unsynchronized transmitter may transmit during a receive cycle of other access points 102. This can cause one or more access points 102 to receive an undesired signal that is strong enough to make the access point insensitive to the desired signal.

As discussed above, prior-art systems feed the clocking signal to each transmitter via separate cabling (i.e., separate from data and power cabling). In order to reduce the amount of cabling within the communication system 100, in the preferred embodiment of the present invention the synchronization pulse is combined with DC power distribution. This is accomplished by interrupting the DC power that is supplied to each access point 102. The interruption occurs on a rising edge of the precision timing reference and lasts for a predetermined time. In particular, in the preferred embodiment of the present invention the precision timing reference occurs every second lasting for 143 microseconds. All access points 102 comprise components that allow the power supplies to operate unaffected by the pulses. For example, power diode 220 is used to block the discharge of a storage capacitor.

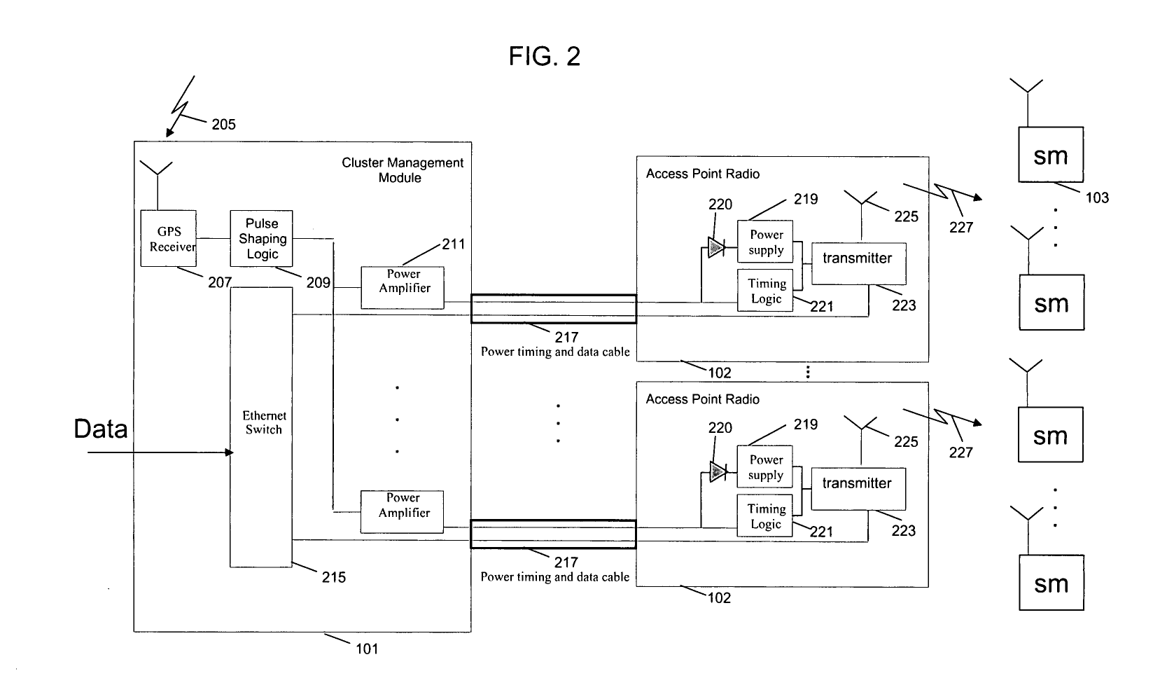

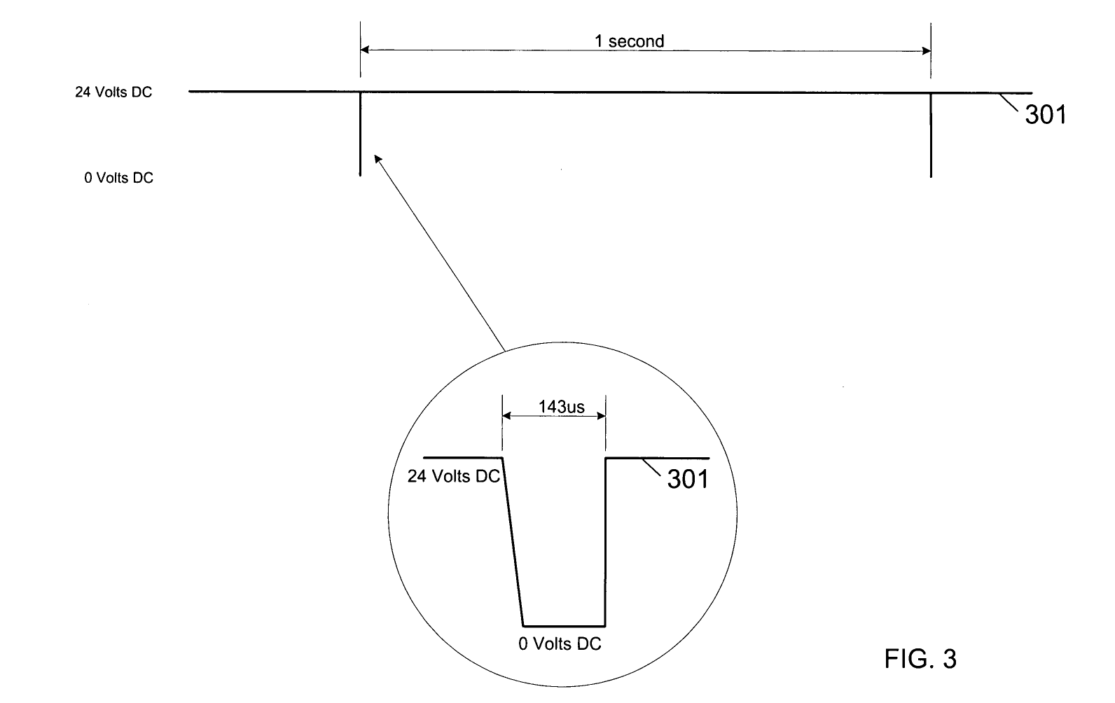

FIG. 2 shows a more-detailed view of cluster management module 101 and access point radio 102. As shown, cluster management module 101 comprises GPS receiver module 207 receiving GPS signal 205. GPS receiver 207 outputs a timing signal between 0 and 3.3 volts, having a rising edge at 1 second intervals. This signal enters pulse-shaping logic 209 where it is utilized to generate the input to amplifier 211. In particular, a DC signal is generated by logic circuitry 209 that is interrupted every second for 143 microseconds. This is illustrated in FIG. 3 where input signal 301 comprises a 24 volt DC signal that is interrupted every second for 143 microseconds. Pulsed-DC signal 301 enters power amplifier 211 where it is amplified and utilized to power access point 102 along with providing a synchronization signal to access point 102. The connection to access point 102 is made via a single power and timing data cable 217. In the preferred embodiment of the present invention cable 217 is a standard Ethernet Cat 5 cable (shielded or unshielded), however in alternate embodiments of the present invention other forms of cabling may be utilized.

Once access point 102 receives the amplified pulsed-DC signal 301, signal 301 is directed towards power supply 219 and timing logic 221. Power supply 219 comprises a storage capacitor utilizing DC signal 301 as a charging source to power transmitter 223. In particular the Canopy radio uses a switching power supply to generate supply voltages that the logic and RF section use for operation. In addition, timing logic 221 utilizes DC signal 301 to properly align transmitter 223. In particular the timing pulse drives a digital phase lock loop (not shown). The digital phase lock loop is used to align every access point radio's 2.5 msec TDM frame. This frame alignment allows the access points 102 and back hauls 104 to synchronize transmit and receive portions of the frame.

Because both access point power and synchronization takes place via the same DC signal, the need for an extra timing cable is eliminated. This technique is preferred over prior-art synchronization techniques since the extra cabling is eliminated without requiring clocking equipment to exist at each access point 102.

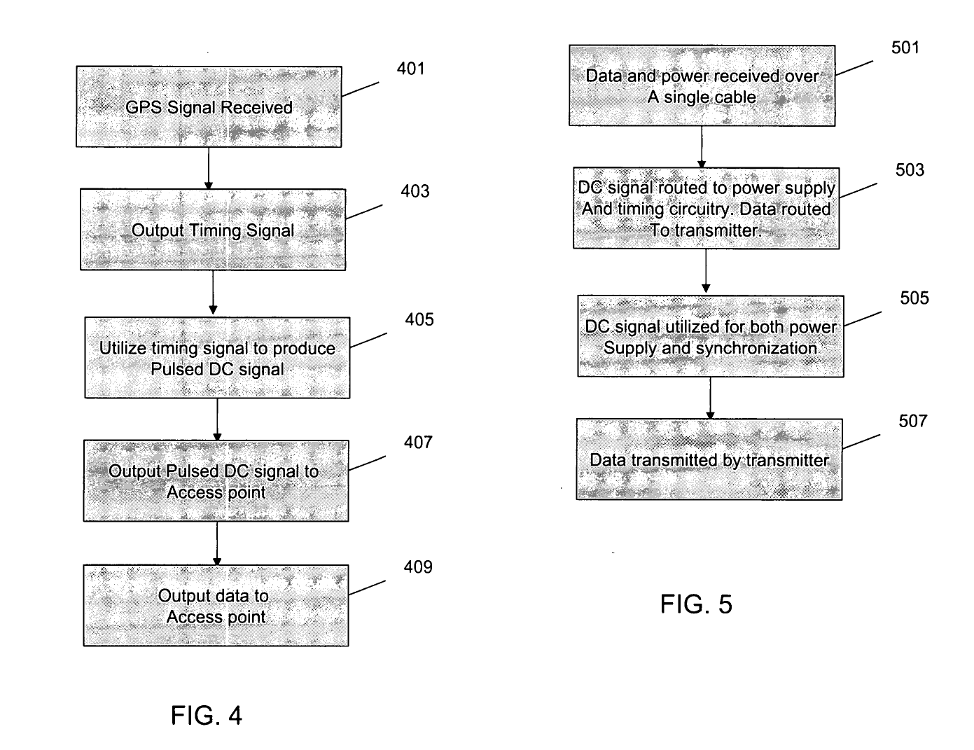

FIG. 4 is a flow chart showing operation of a cluster management module of FIG. 2. The logic flow begins at step 401 where GPS receiver 207 receives an external timing signal (i.e., GPS signal 205). At step 403 GPS receiver 207 outputs a standard GPS timing signal between 0 and 3.3 volts, having a rising edge at 1 second intervals. This signal enters logic circuitry 209 where at step 405 the timing signal is utilized to produce pulsed-DC signal 301. More particularly, at step 405, pulse-shaping logic 209 utilizes the GPS timing signal to produce 24 volt DC signal 301 that is interrupted every second for a predetermined amount of time (e.g., 143 microseconds). At step 407, the pulsed-DC signal 301 is amplified and output to access point radio for use as both a timing source and a power supply. Data is additionally output to the access point radio at step 409. As discussed above, a single cable is utilized for both power and data. Utilizing the pulsed-DC signal as both a power source and a timing source for data transmission is preferred over prior-art synchronization techniques since the above technique does not require clocking equipment to exist at each access point 102, nor does it require excess cabling utilized to provide the clocking signal.

FIG. 5 is a flow chart showing operation of an access point radio of FIG. 2. The logic flow begins at step 501 where data and power (amplified pulsed-DC signal 301) are received via cable 217. As discussed above, a single Ethernet Cat 5 cable is utilized to provide power and data to access point 102. At step 503 the DC signal is routed to power supply 219 and to timing circuitry 221, while the data is routed to transmitter 223. At step 505 the DC signal is utilized as both a power supply for transmitter 223 and as a timing signal for synchronizing transmission of data. More particularly, the periodic interruption of the DC signal provides a timing source that is utilized by access point radio 102. This timing source is utilized to prevent transmission by an access point during a receive cycle of other access points 102. Finally, at step 507 synchronized data is transmitted to a service module.

While the invention has been particularly shown and described with reference to a particular embodiment, it will be understood by those skilled in the art that various changes in form and details may be made therein without departing from the spirit and scope of the invention. For example, although timing logic 221 and power supply 219 are shown existing outside transmitter 223, one of ordinary skill in the art will recognize that such circuitry may be located within transmitter 223. Additionally, although the pulsed-DC signal is produced based on a received GPS signal, one of ordinary skill in the art will recognize that the pulsed-DC signal may be created based on any highly-accurate clocking source. It is intended that such changes come within the scope of the following claims.

1. A method for synchronizing transmissions, the method comprising the steps of:
utilizing a timing signal to produce a pulsed-DC signal; and
outputting the pulsed-DC signal to a radio, wherein the pulsed-DC signal is utilized both to power the radio, and as a timing source for synchronization purposes.

2. The method of claim 1 further comprising the steps of:
outputting data to the radio; and
wherein the pulsed-DC signal is utilized both to power the radio, and as a timing source to synchronize transmission of the data.

3. The method of claim 2 wherein the step of outputting data to the radio comprises the step of outputting the data and the pulsed-DC signal over a single cable.

4. The method of claim 3 wherein the step of outputting the data and the pulsed-DC signal over the single cable comprises the step of outputting the data and the pulsed-DC signal over an Ethernet Cat 5 cable.

5. The method of claim 1 further comprising the steps of:
receiving an external timing signal; and
wherein the step of utilizing the timing signal to produce the pulsed-DC signal comprises the step of utilizing the external timing signal to produce the pulsed-DC signal.

6. The method of claim 1 further comprising the steps of:
receiving a GPS signal; and
wherein the step of utilizing the timing signal to produce the pulsed-DC signal comprises the step of utilizing the GPS signal to produce the pulsed-DC signal.

7. A method for synchronizing transmission within a communication system, the method comprising the steps of:
receiving a pulsed-DC signal; and
utilizing the pulsed-DC signal as both a power source and as a timing signal for synchronizing transmissions.

8. The method of claim 7 further comprising the steps of:
receiving data; and
wherein the step of utilizing the pulsed-DC signal comprises the step of utilizing the pulsed-DC signal as both a power source and as a timing signal for synchronizing transmission of the data.

9. The method of claim 8 wherein the steps of receiving data and receiving the pulsed-DC signal comprises the steps of receiving both the data and the pulsed-DC signal over a single cable.

10. The method of claim 8 wherein the steps of receiving data and receiving the pulsed-DC signal comprises the steps of receiving both the data and the pulsed-DC signal over a single Ethernet Cat 5 cable.

11. An apparatus comprising:
pulse-shaping logic having a timing signal as an input and outputting a pulsed-DC signal; and
a power amplifier having the pulsed-DC signal as an input and outputting the pulsed-DC signal to a radio, wherein the pulsed-DC signal is utilized both to power the radio, and as a timing source for synchronization purposes.

12. The apparatus of claim 11 further comprising:
an Ethernet switch outputting data to the radio; and
wherein the pulsed-DC signal is utilized both to power the radio, and as a timing source to synchronize transmission of the data.

13. The apparatus of claim 12 wherein the data and the pulsed-DC signal are output to the radio over a single cable.

14. The apparatus of claim 13 wherein the data and the pulsed-DC signal are output to the radio over a single Ethernet Cat 5 cable.

15. The apparatus of claim 11 further comprising:
an external receiver receiving an external timing signal; and
wherein the external timing signal is utilized by the pulse-shaping logic to produce the pulsed-DC signal.

16. The apparatus of claim 11 further comprising:
a GPS receiver receiving an external GPS signal; and
wherein the GPS signal is utilized by the pulse-shaping logic to produce the pulsed-DC signal.

17. An apparatus comprising:
a power supply receiving a pulsed-DC signal;
timing circuitry receiving the pulsed-DC signal, and outing a timing signal; and
a transmitter utilizing the power supply as a power source and utilizing the iteming signal for synchronization.

18. The apparatus of claim 17 wherein the transmitter additionally receives data, and wherein the data and the pulsed-DC signal are received over a single cable.

19. The apparatus of claim 18 wherein the single cable comprises an Ethernet Cat 5 cable.
